(19) United States
(12) Patent Application Publication
(10) Pub. No.: US 2023/0383661 A1
(43) Pub. Date: Nov. 30, 2023

(54) TURBINE STATOR VANE AND GAS TURBINE

(71) Applicant: MITSUBISHI HEAVY INDUSTRIES, LTD., Tokyo (JP)

(72) Inventors: Saki MATSUO, Tokyo (JP); Yasuo MIYAHISA, Tokyo (JP); Shunsuke TORII, Tokyo (JP)

(21) Appl. No.: 18/142,725

(22) Filed: May 3, 2023

(30) Foreign Application Priority Data
May 24, 2022 (JP) 2022-084383

(51) Int. Cl. F01D 9/04; F02C 7/00

(52) U.S. Cl. CPC F01D 9/041; F02C 7/00; F05D 2240/12

(57) ABSTRACT

A turbine stator vane includes: a blade body having an outer end and an inner end in a blade height direction; a cooling passage extending along the blade height direction inside the blade body; an outer shroud connected to the blade body at the outer end side of the blade body in the blade height direction; an inner shroud connected to the blade body at the inner end side of the blade body in the blade height direction; and an internal passage forming part extending along the blade height direction inside the cooling passage. The internal passage forming part forms an internal passage communicating with each of an outer space on an opposite side to the blade body across the outer shroud and an inner space on an opposite side to the blade body across the inner shroud.

### TECHNICAL FIELD

The present disclosure relates to a turbine stator vane and a gas turbine.

The present application claims priority based on Japanese Patent Application No. 2022-084383 filed on May 24, 2022, the entire content of which is incorporated herein by reference.

### BACKGROUND

Efficient cooling of a turbine blade with a cooling passage inside the blade body has been proposed.

For example, Patent Document 1 discloses a turbine blade including a blade body having a base portion and a tip portion, and a structure provided in a base-side portion of a cooling passage extending inside the blade body in the blade height direction. By providing the structure on the base side where the flow path area of the cooling passage is relatively large, the flow velocity of the cooling fluid is increased on the base side to increase the heat transfer coefficient, so that the turbine blade is efficiently cooled.

### CITATION LIST

### Patent Literature

Patent Document 1: JP2009-91911 A

### SUMMARY

The turbine blade disclosed in Patent Document 1 has a relatively complicated structure due to a new structure provided in the cooling passage formed inside the blade body to efficiently cool the turbine blade.

In view of the above, an object of at least one embodiment of the present invention is to provide a turbine stator vane and a gas turbine whereby it is possible to effectively and efficiently cool the turbine stator vane while reducing the complexity of the structure.

A turbine stator vane according to at least one embodiment of the present invention includes: a blade body having an outer end and an inner end in a blade height direction; a cooling passage extending along the blade height direction inside the blade body; an outer shroud connected to the blade body at the outer end side of the blade body in the blade height direction; an inner shroud connected to the blade body at the inner end side of the blade body in the blade height direction; and an internal passage forming part extending along the blade height direction inside the cooling passage. The internal passage forming part forms an internal passage communicating with each of an outer space on an opposite side to the blade body across the outer shroud and an inner space on an opposite side to the blade body across the inner shroud. The internal passage forming part has: a first portion; and a second portion disposed closer to the outer end than the first portion in the blade height direction. An area enclosed by an outer edge of the second portion in a second cross-section perpendicular to the blade height direction is larger than an area enclosed by an outer edge of the first portion in a first cross-section perpendicular to blade height direction.

A gas turbine according to at least one embodiment of the present invention includes: a turbine including the above-described turbine stator vane; and a combustor for producing a combustion gas to flow through a combustion gas passage in which the turbine stator vane is disposed.

At least one embodiment of the present invention provides a turbine stator vane and a gas turbine whereby it is possible to effectively and efficiently cool the turbine stator vane while reducing the complexity of the structure.

### BRIEF DESCRIPTION OF DRAWINGS

FIG. 1 is a schematic configuration diagram of a gas turbine according to an embodiment.

FIG. 2 is a schematic diagram of a part of a turbine including a stator vane according to an embodiment.

FIG. 3 is a schematic partial cross-sectional view of the stator vane shown in FIG. 2 along the blade height direction.

FIG. 4A is a cross-sectional view taken along line A-A of FIG. 3.

FIG. 4B is a cross-sectional view taken along line B-B of FIG. 3.

FIG. 4C is a cross-sectional view taken along line C-C of FIG. 3.

FIG. 5 is a schematic diagram showing a portion of the stator vane on the leading edge and radially outer side according to an embodiment.

FIG. 6 is a schematic diagram showing a portion of the stator vane on the leading edge and radially outer side according to an embodiment.

FIG. 7 is a schematic diagram showing a portion of the stator vane on the leading edge and radially outer side according to an embodiment.

FIG. 8 is a schematic diagram showing a portion of the stator vane on the leading edge and radially outer side according to an embodiment.

### DETAILED DESCRIPTION

Embodiments of the present invention will now be described in detail with reference to the accompanying drawings. It is intended, however, that unless particularly identified, dimensions, materials, shapes, relative positions, and the like of components described in the embodiments shall be interpreted as illustrative only and not intended to limit the scope of the present invention.

(Configuration of Gas Turbine)

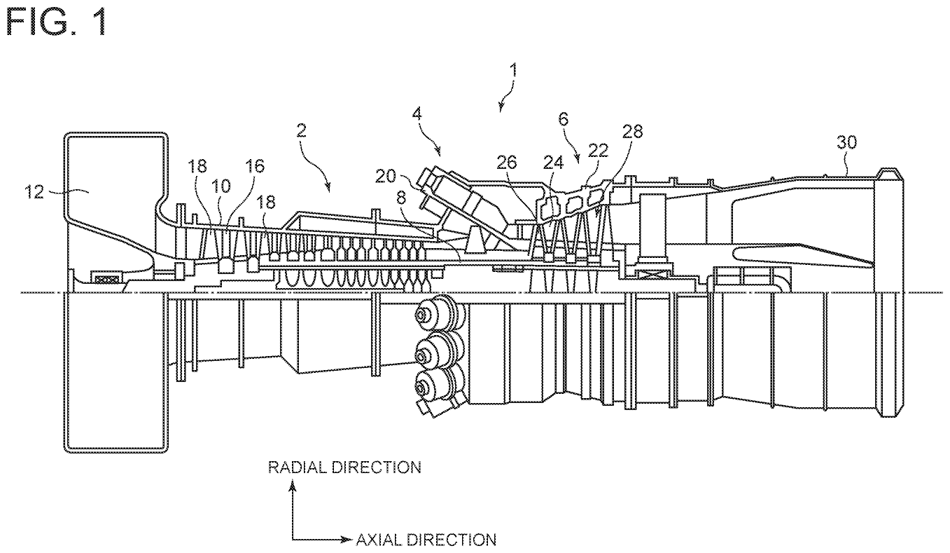

First, a gas turbine to which a turbine stator vane according to some embodiments is applied will be described. FIG. 1 is a schematic configuration diagram of a gas turbine to which a turbine blade according to an embodiment is applied. As shown in FIG. 1, the gas turbine 1 includes a compressor 2 for producing compressed air, a combustor 4 for producing combustion gas from the compressed air and fuel, and a turbine 6 configured to be rotationally driven by the combustion gas. In the case of the gas turbine 1 for power generation, a generator (not shown) is connected to the turbine 6.

The compressor 2 includes a plurality of stator vanes 16 fixed to a compressor casing 10 and a plurality of rotor blades 18 implanted on a rotor 8 alternately with the stator vanes 16. Intake air from an air inlet 12 is sent to the compressor 2. The air passes through the plurality of stator vanes 16 and the plurality of rotor blades 18 and is compressed into compressed air having high temperature and high pressure.

The combustor 4 is supplied with fuel and the compressed air generated by the compressor 2. In the combustor 4, the fuel and the compressed air are mixed and combusted to generate the combustion gas which serves as a working fluid of the turbine 6. As shown in FIG. 1, a plurality of combustors 4 may be disposed along the circumferential direction in the combustor casing 20, centering around the rotor.

The turbine 6 has a combustion gas passage 28 formed in a turbine casing 22 and includes a plurality of stator vanes 24 and a plurality of rotor blades 26 disposed in the combustion gas passage 28. The stator vanes 24 are fixed to the turbine casing 22, and a set of the stator vanes 24 arranged along the circumferential direction of the rotor 8 forms a stator vane row. Further, the rotor blades 26 are mounted on the rotor 8, and a set of the rotor blades 26 arranged along the circumferential direction of the rotor 8 forms a rotor blade row. The stator vane rows and the rotor blade rows are alternately arranged in the axial direction of the rotor 8.

In the turbine 6, as the combustion gas introduced from the combustor 4 into the combustion gas passage 28 passes through the plurality of stator vanes 24 and the plurality of rotor blades 26, the rotor 8 is rotationally driven. Thereby, the generator connected to the rotor 8 is driven to generate power. The combustion gas having driven the turbine 6 is discharged to the outside via an exhaust chamber 30.

(Configuration of Turbine Stator Vane)

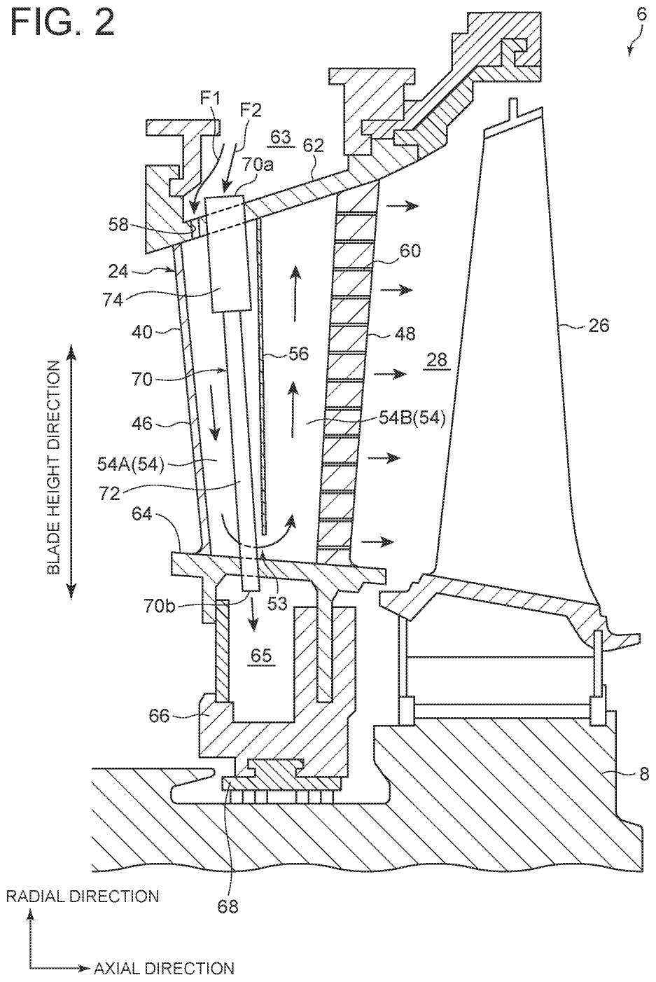

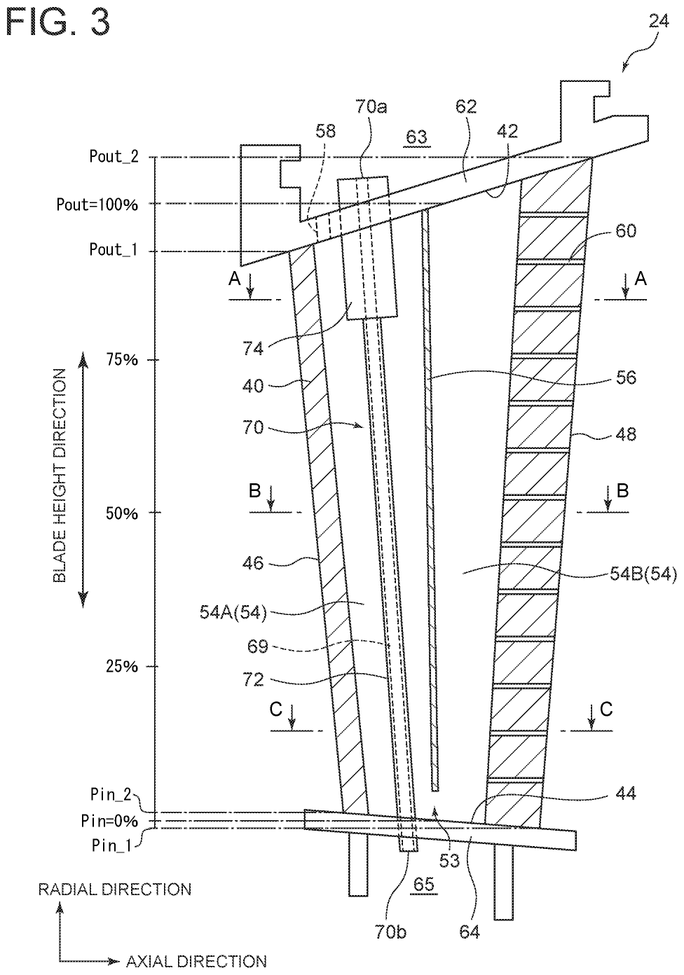

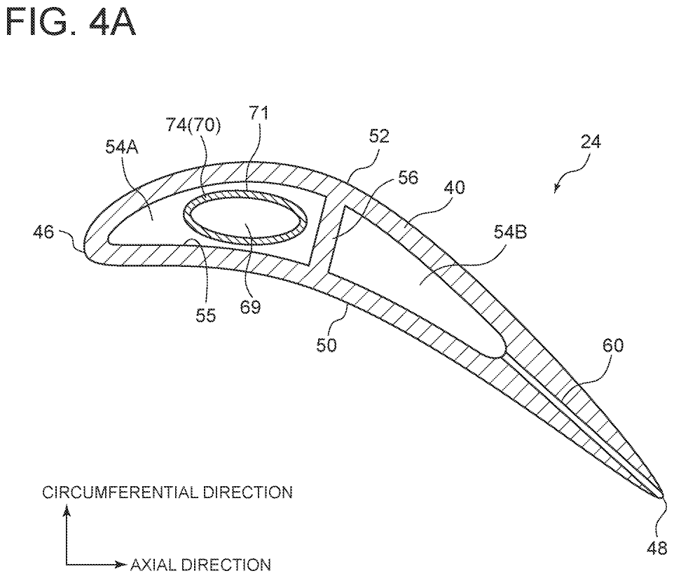

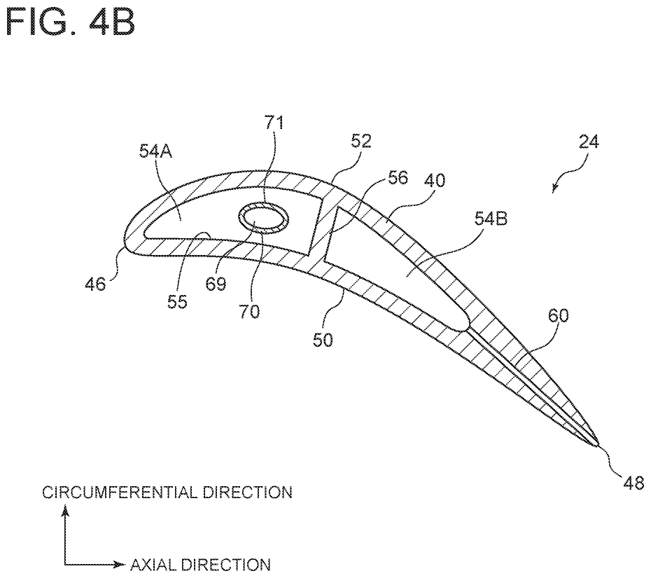

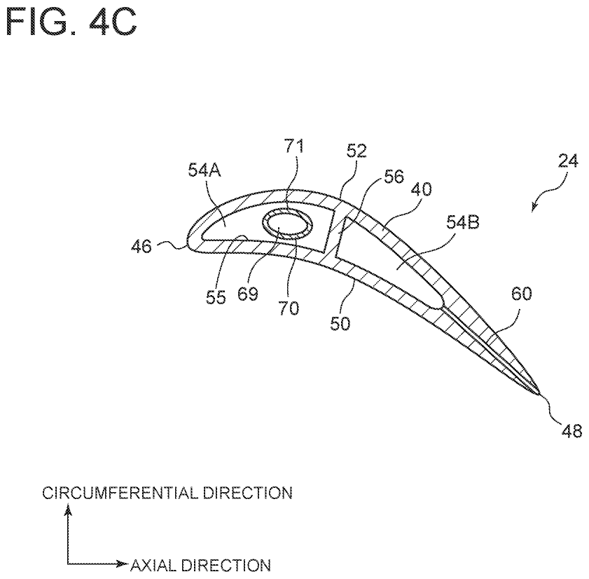

Hereinafter, the stator vane 24 (turbine stator vane) of the turbine 6 according to some embodiments will be described. FIG. 2 is a schematic diagram of a part of the turbine 6 including the stator vane 24 according to an embodiment. FIG. 3 is a schematic partial cross-sectional view of the stator vane 24 shown in FIG. 2 along the blade height direction. FIGS. 4A to 4C are cross-sectional views taken along lines A-A, B-B, and C-C of FIG. 3, respectively. The “radial direction”, “axial direction”, and “circumferential direction” in the figures respectively refer to the radial direction, axial direction, and circumferential direction of the turbine 6 (or turbine rotor).

As shown in FIGS. 2 to 4C, the stator vane 24 according to an embodiment includes a blade body 40, an outer shroud 62 and an inner shroud 64 connected to both end portions of the blade body 40 in the blade height direction. Here, the blade height direction of the stator vane 24 (i.e., the blade height direction of the blade body 40) corresponds to the radial direction of the turbine rotor on which the stator vane 24 is installed. When the stator vane 24 is installed in the turbine 6, the outer shroud 62 is disposed radially outward of the blade body 40, and the inner shroud 64 is disposed radially inward of the blade body 40.

The blade body 40 has an outer end 42 and an inner end 44 which are opposite ends in the blade height direction. The outer end 42 is an end portion on the radially outer side of the blade body 40, and the inner end 44 is an end portion on the radially inner side of the blade body 40. The blade body 40 has a leading edge 46 and a trailing edge 48 extending from the outer end 42 to the inner end 44 along the blade height direction. The blade surface of the blade body 40 includes a positive-pressure surface (pressure surface) 50 and a negative-pressure surface (suction surface) 52 extending along the blade height direction between the outer end 42 and the inner end 44 (see FIGS. 4A to 4C). The pressure surface 50 and the suction surface 52 are connected at the leading edge 46 and the trailing edge 48.

The outer shroud 62 is connected to the blade body 40 at the outer end 42 side of the blade body 40 in the blade height direction. The outer shroud 62 is supported by the turbine casing 22 (see FIG. 1), and the stator vane 24 is supported by the turbine casing 22 via the outer shroud 62. An outer space 63 is formed on the opposite side to the blade body 40 across the outer shroud 62. The outer space 63 is at least partially defined by the outer shroud 62.

The inner shroud 64 is connected to the blade body 40 at the inner end 44 side of the blade body 40 in the blade height direction. A seal ring retaining ring 66 for holding a seal ring 68 is disposed on the opposite side to the blade body 40 across the inner shroud 64 in the blade height direction. The seal ring 68 is provided to suppress fluid leakage through a space between the rotor 8 and the stator vane 24. An inner space 65 is formed on the opposite side to the blade body 40 across the inner shroud 64. The inner space 65 is at least partially defined by the inner shroud 64 and the seal ring retaining ring 66.

A cooling passage 54 extending along the blade height direction is disposed inside the blade body 40. The cooling passage 54 is configured to flow a cooling fluid F1 (e.g., air) to cool the stator vane 24.

In some embodiments, for example, as shown in FIGS. 2 to 4, a plurality of (two in FIGS. 2 to 4C) cooling passages 54 (54A, 54B) may be formed inside the blade body 40. As shown in FIGS. 2 to 4C, a pair of adjacent cooling passages 54 (cooling passage 54A and cooling passage 54B) of the plurality of cooling passages 54 (54A, 54B) may be separated by a rib 56 extending along the blade height direction.

As shown in FIGS. 2 to 4C, the plurality of cooling passages 54 (54A, 54B) may be connected to each other via a return portion 53 disposed at an end portion of the plurality of cooling passages 54 in the blade height direction to form a serpentine passage (meandering passage). In this case, at this return portion 53, a return passage is formed where the direction of flow of the cooling fluid turns back in the blade height direction.

As shown in FIGS. 2 to 4C, the plurality of cooling passages 54 (54A, 54B) may be arranged along the chord direction of the blade body 40 (the direction connecting the leading edge 46 and the trailing edge 48). In the illustrated embodiment, the plurality of cooling passages 54A, 54B are arranged in this order in the chord direction from the leading edge 46 to the trailing edge 48. Of the plurality of cooling passages 54, the cooling passage 54 closest to the leading edge 46 in the chord direction (cooling passage 54A in the illustrated embodiment) is the leadingmost passage.

The cooling fluid F1 may be introduced into the cooling passages 54 from the outer space 63. The cooling fluid may be supplied to the outer space 63 via a passage not shown. In the illustrated embodiment, the cooling fluid F1 from the outer space 63 is introduced into the cooling passage 54A via a passage 58 provided in the outer shroud 62, flows along the cooling passage 54A along the blade height direction, and flows into cooling passage 54B via the return portion 53. The cooling fluid F1 flowing through the cooling passage 54B may be discharged into the combustion gas passage 28 through cooling holes 60 in the trailing edge portion of the blade body 40.

As shown in FIGS. 2 to 4C, the stator vane 24 includes an internal passage forming part 70 extending along the blade height direction inside the cooling passage 54. In the illustrated embodiment, the internal passage forming part 70 is disposed so as to extend inside the cooling passage 54A. Further, in the illustrated embodiment, the internal passage forming part 70 is disposed so as to extend along the blade height direction.

The internal passage forming part 70 forms an internal passage 69 communicating with each of the outer space 63 and the inner space 65. In the illustrated embodiment, the internal passage forming part 70 has an inlet opening 70a and an outlet opening 70b opening at both end portions of the internal passage forming part 70, and the internal passage 69 extends between the inlet opening 70a and the outlet opening 70b. The internal passage 69 communicates with the outer space 63 through the inlet opening 70a and with the inner space 65 through the outlet opening 70b. This allows a fluid F2 from the outer space 63 to be directed into the inner space 65 via the internal passage 69. The fluid F2 may be a seal fluid to prevent fluid (such as combustion gas) from entering the inner space 65 from the combustion gas passage 28. The cooling fluid F1 and fluid F2 may be supplied from the same fluid source. As depicted, the internal passage forming part 70 may be disposed to penetrate the blade body 40.

The internal passage forming part 70 has a first portion 72 and a second portion 74 disposed closer to the outer end 42 than the first portion 72 in the blade height direction. Further, an area enclosed by an outer edge 71 of the second portion 74 in a cross-section (second cross-section, for example, cross-section A-A (see FIG. 4A)) perpendicular to the blade height direction is larger than an area enclosed by an outer edge 71 of the first portion 72 in a cross-section (first cross-section, for example, cross-section B-B (see FIG. 4B)) perpendicular to blade height direction.

In other words, the internal passage forming part 70 has a second portion 74 that is located closer to the outer end 42 (on the radially outer side) in the blade height direction and has a locally larger area enclosed by the outer edge 71 than the first portion 72. For example, the area enclosed by the outer edge 71 of the second portion 74 in the second cross-section may be not less than twice the area enclosed by the outer edge 71 of the first portion 72 in the first cross-section.

The first cross-section is the cross-section within a range where the first portion exists in the blade height direction, and the second cross-section is the cross-section within a range where the second portion exists in the blade height direction. The second cross-section is located radially outward of the first cross-section.

In the above-described embodiment, the fluid F2 (seal fluid) can flow from the outer space 63 to the inner space 65 via the internal passage 69 formed by the internal passage forming part 70. That is, the internal passage forming part 70 can serve as a seal tube. Additionally, in the above-described embodiment, since the area enclosed by the outer edge 71 of the second portion 74 in the cross-section (second cross-section) perpendicular to the blade height direction is larger than the area enclosed by the outer edge 71 of the first portion 72 in the cross-section (first cross-section) perpendicular to the blade height direction, the flow path area of the cooling fluid F1 flowing through the cooling passage 54A (effective cross-sectional area of cooling passage 54A) tends to be relatively large on the outer end 42 side (radially outer side) and relatively small on the inner end 44 side (radially inner side) in the blade height direction. Therefore, the flow velocity of the cooling fluid F1 can be increased on the outer end 42 side, where the cooling load is relatively high, so that the heat transfer coefficient between the cooling fluid F1 and the stator vane 24 can be increased on the outer end 42 side, whereas the increase in flow velocity of the cooling fluid F1 can be suppressed on the inner end 44 side, where the cooling load is relatively low, so that the pressure loss of the cooling fluid F1 can be decreased to reduce the supply pressure (supply volume) of the cooling fluid F1. Therefore, the stator vane 24 can be cooled effectively and efficiently.

Thus, according to the above-described embodiment, it is possible to effectively and efficiently cool the stator vane 24 while reducing the complexity of the structure by utilizing the internal passage forming part 70.

The stator vane 24 of the turbine tends to be hotter in a radially outer portion, and the stress applied to this portion may be higher. In this case, as described above, the cooling load on the radially outer portion of the stator vane 24 (the portion near the outer end 42) is higher.

In some embodiments, the effective cross-sectional area of the cooling passage 54 (cooling passage in which the internal passage forming part 70 is disposed; cooling passage 54A in the illustrated example) in the second cross-section is smaller than the effective cross-sectional area of the cooling passage 54 in the first cross-section. Here, the effective cross-sectional area of the cooling passage 54 (54A) is the flow path area of the cooling fluid F1 flowing through the cooling passage 54 (54A), and is the difference (Sa-Sb) between the area Sa enclosed by the inner wall surface 55 (see FIGS. 4A to 4C) of the cooling passage 54 (54A) and the area Sb enclosed by the outer edge 71 of the internal passage forming part in a cross-section (e.g., first or second cross-section) perpendicular to the blade height direction.

In other words, in the cooling passage 54 (54A) in which the internal passage forming part 70 is disposed, there is a region where the effective cross-sectional area is locally large, and this region is the range where the second portion 74 of the internal passage forming part 70 is located in the blade height direction (that is, the region located on the relatively radially outer side).

According to the above-described embodiment, the effective cross-sectional area of the cooling passage 54 in the second cross-section on the outer end 42 side (radially outer side) is smaller than the effective cross-sectional area of the cooling passage 54 in the first cross-section on the inner end 44 side (radially inner side). Therefore, the flow velocity of the cooling fluid F1 can be increased on the outer end 42 side, where the cooling load is relatively high, so that the heat transfer coefficient between the cooling fluid F1 and the stator vane 24 can be increased on the outer end 42 side, whereas the increase in flow velocity of the cooling fluid F1 can be suppressed on the inner end 44 side, where the cooling load is relatively low, so that the pressure loss of the cooling fluid F1 can be decreased to reduce the supply pressure (supply volume) of the cooling fluid F1. Thus, as described above, it is possible to effectively and efficiently cool the stator vane 24 while reducing the complexity of the structure.

In some embodiments, for example, as shown in FIGS. 2 to 4C, the internal passage forming part 70 extends inside a leading-edge-side passage (cooling passage 54A) disposed closest to the leading edge 46 in the chord direction among the plurality of cooling passages 54.

The stator vane 24 of the turbine 6 tends to be hotter near the leading edge 46 during operation of the turbine 6. In this regard, according to the above-described embodiment, the internal passage forming part 70 extends inside the leading-edge-side passage (cooling passage 54A) disposed closest to the leading edge among the plurality of cooling passages 54 disposed inside the blade body 40. Therefore, the stator vane 24 can be cooled more effectively.

Here, the average position Pin of the inner end 44 in the blade height direction is defined as blade height position 0%, and the average position Pout of the outer end 42 in the blade height direction is defined as blade height position 100% (see FIG. 3). The average position Pin of the inner end 44 in the blade height direction is the arithmetic mean (Pin_1+Pin_2)/2 of the radially innermost position Pin_1 and the radially outermost position Pin_2 of the inner end 44. The average position Pout of the outer end 42 in the blade height direction is the arithmetic mean (Pout_1+Pout_2)/2 of the radially innermost position Pout_1 and the radially outermost position Pout_2 of the outer end 42.

In some embodiments, the first portion 72 of the internal passage forming part 70 extends in the blade height direction within a range including the blade height position 50%.

According to the above-described embodiment, since the first portion 72 of the internal passage forming part 70 extends in the blade height direction within a range including the blade height position 50%, the second portion 74 is located at a position closer to the outer end 42 where the blade height position is more than 50%. Therefore, the flow velocity of the cooling fluid F1 can be effectively increased on the outer end 42 side, where the cooling load is relatively high, so that the heat transfer coefficient between the cooling fluid F1 and the stator vane 24 can be effectively increased on the outer end 42 side, whereas the increase in flow velocity of the cooling fluid F1 can be suppressed in a region on the inner end 44 side (region including the blade height position 50%), where the cooling load is relatively low, so that the pressure loss of the cooling fluid F1 can be decreased to reduce the supply pressure (supply volume) of the cooling fluid F1.

In some embodiments, the second portion 74 of the internal passage forming part 70 is at least partially disposed within the range where the blade height position is not less than 75% and not more than 100%. In the exemplary embodiment shown in FIG. 3, the second portion 74 is partially disposed within the range where the blade height position is not less than 75% and not more than 100%.

According to the above-described embodiment, since the second portion 74 of the internal passage forming part 70 is at least partially disposed within the range where the blade height position is not less than 75% and not more than 100%, the flow velocity of the cooling fluid F1 can be effectively increased on the outer end 42 side, where the cooling load is relatively high, so that the heat transfer coefficient between the cooling fluid F1 and the stator vane 24 can be effectively increased on the outer end 42 side, whereas the increase in flow velocity of the cooling fluid F1 can be suppressed on the inner end 44 side, where the cooling load is relatively low, so that the pressure loss of the cooling fluid F1 can be decreased to reduce the supply pressure (supply volume) of the cooling fluid F1.

In some embodiments, for example, as shown in FIG. 3, the first portion 72 includes a portion of the internal passage forming part 70 where the blade height position is not less than 0% and not more than 50%.

According to the above-described embodiment, the first portion 72 includes a portion of the internal passage forming part 70 where the blade height position is not less than 0% and not more than 50%. That is, since most of the internal passage forming part 70 on the inner end 44 side is the first portion 72, the increase in flow velocity of the cooling fluid F1 is suppressed in most of the internal passage forming part 70 on the inner end 44 side, so that the pressure loss of the cooling fluid F1 can be decreased to effectively reduce the supply pressure (supply volume) of the cooling fluid.

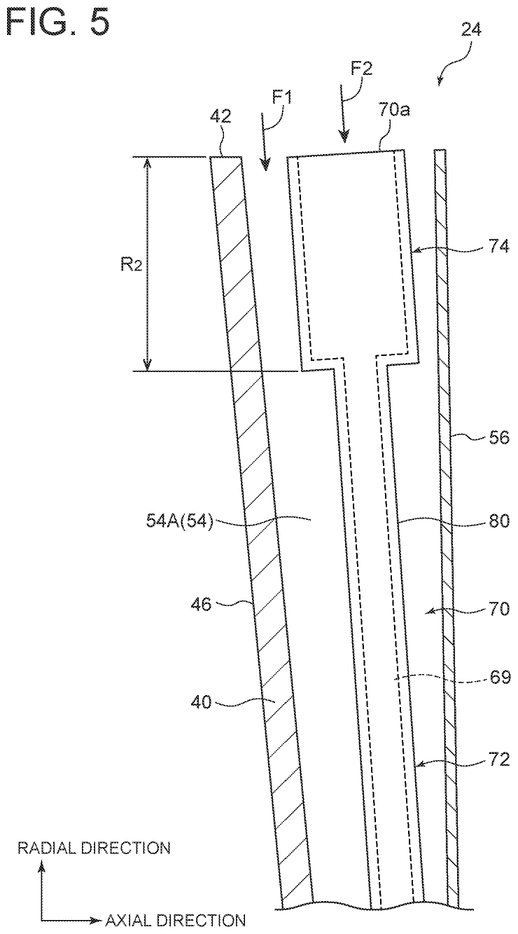

FIGS. 5 to 8 are each a schematic diagram showing a portion of the stator vane 24 on the leading edge and radially outer side according to an embodiment. In FIGS. 5 to 8, the outer shroud 62 is not depicted.

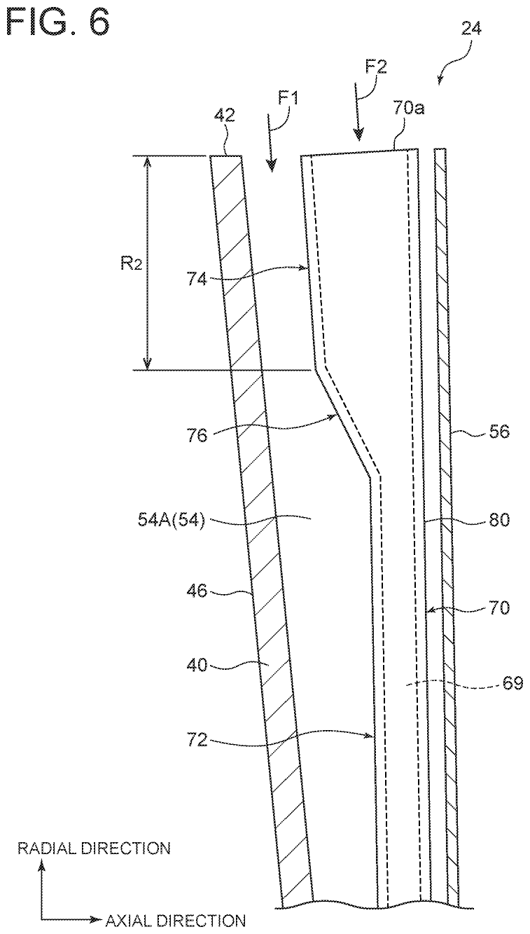

In the exemplary embodiments shown in FIGS. 5 and 6, the internal passage forming part 70 includes a tubular member 80 extending along the blade height direction between the outer end 42 and the inner end 44 (see FIG. 3). The first portion 72 and the second portion 74 are formed by one tubular member 80.

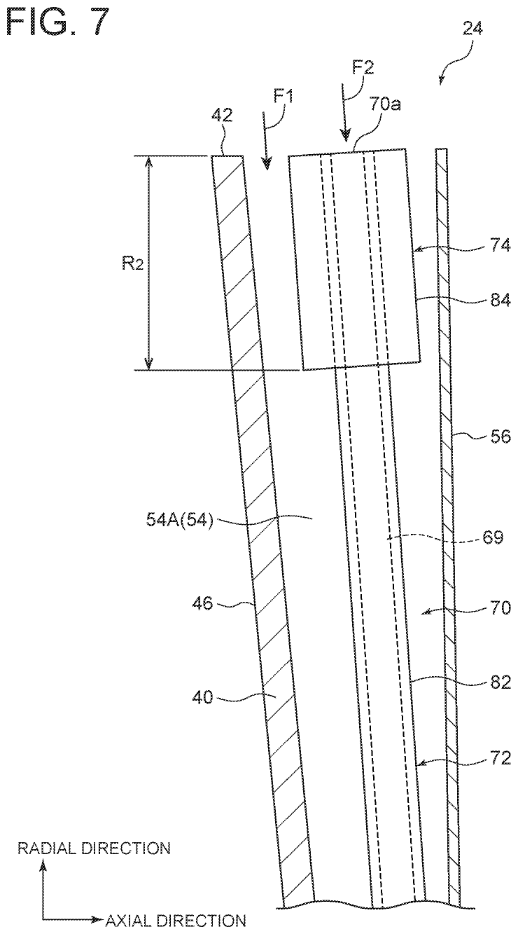

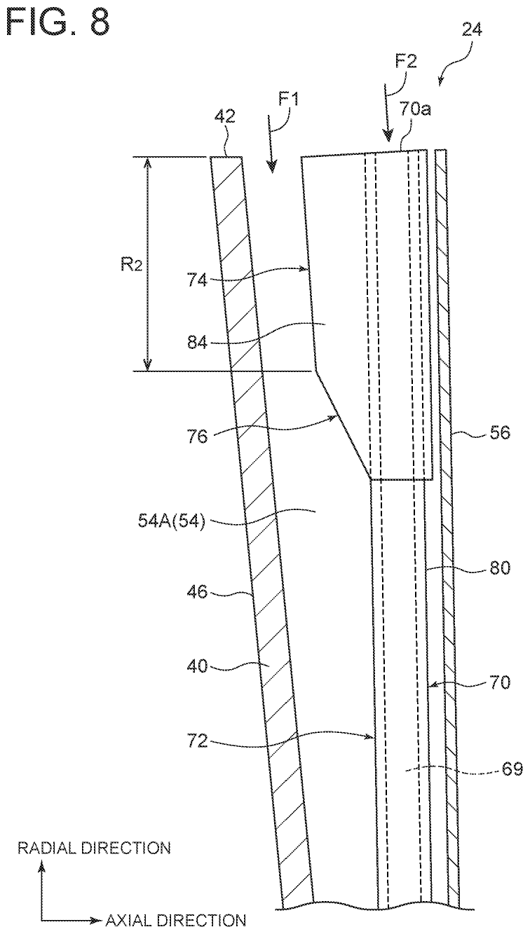

In the exemplary embodiments shown in FIGS. 7 and 8, the internal passage forming part 70 includes a tubular member 82 extending along the blade height direction between the outer end 42 and the inner end 44 (see FIG. 3), and a cover member 84 covering a portion of the tubular member 82 in the blade height direction from the periphery. The first portion 72 is formed by the tubular member 82. The second portion 74 is formed by the tubular member 82 and the cover member 84. That is, the second portion 74 includes the cover member 84. The outer edge 71 (see FIG. 4A) of the second portion 74 is formed by the cover member 84.

According to the exemplary embodiments shown in FIGS. 5 to 8, the internal passage forming part 70 including the first portion 72 and the second portion 74 can be formed by the tubular member 80 or by the tubular member 82 and the cover member 84. Thus, the stator vane 24 including the internal passage forming part 70 can be obtained with a simple configuration.

In some embodiments, for example, as shown in FIGS. 6 and 8, a connecting portion 76 that connects the first portion 72 and the second portion 74 may be disposed between the first portion 72 and the second portion 74. As shown in FIGS. 6 and 7, the connecting portion 76 may be a portion where the size of the outer edge 71 (or the area enclosed by the outer edge 71 in a cross-section perpendicular to the blade height direction; see FIGS. 4A to 4C) gradually increases from the first portion 72 to the second portion 74. In this case, the effective cross-sectional area of the cooling passage 54 (54A) gradually changes so that the flow of the cooling fluid F1 along the internal passage forming part 70 in the cooling passage 54 (54A) becomes smoother, allowing the stator vane 24 to be cooled more efficiently.

The contents described in the above embodiments would be understood as follows, for instance.

(1) A turbine stator vane (24) according to at least one embodiment of the present invention includes: a blade body (40) having an outer end (42) and an inner end (44) in a blade height direction; a cooling passage (54) extending along the blade height direction inside the blade body; an outer shroud (62) connected to the blade body at the outer end side of the blade body in the blade height direction; an inner shroud (64) connected to the blade body at the inner end side of the blade body in the blade height direction; and an internal passage forming part (70) extending along the blade height direction inside the cooling passage. The internal passage forming part forms an internal passage (69) communicating with each of an outer space (63) on an opposite side to the blade body across the outer shroud and an inner space (65) on an opposite side to the blade body across the inner shroud. The internal passage forming part has: a first portion (72); and a second portion (74) disposed closer to the outer end than the first portion in the blade height direction. An area enclosed by an outer edge (71) of the second portion in a second cross-section perpendicular to the blade height direction is larger than an area enclosed by an outer edge (71) of the first portion in a first cross-section perpendicular to blade height direction.

In the above configuration (1), a seal fluid can flow from the outer space to the inner space via the internal passage formed by the internal passage forming part. That is, the internal passage forming part can serve as a seal tube. Additionally, in the above configuration (1), since the area enclosed by the outer edge of the second portion in the second cross-section perpendicular to the blade height direction is larger than the area enclosed by the outer edge of the first portion in the first cross-section, the flow path area of the cooling fluid flowing through the cooling passage (effective cross-sectional area of cooling passage) tends to be relatively large on the outer end side (radially outer side) and relatively small on the inner end side (radially inner side) in the blade height direction. Therefore, the flow velocity of the cooling fluid can be increased on the outer end side, where the cooling load is relatively high, so that the heat transfer coefficient between the cooling fluid and the turbine stator vane can be increased on the outer end side, whereas the increase in flow velocity of the cooling fluid can be suppressed on the inner end side, where the cooling load is relatively low, so that the pressure loss of the cooling fluid can be decreased to reduce the supply pressure (supply volume) of the cooling fluid. Therefore, the turbine stator vane can be cooled effectively and efficiently.

Thus, with the above configuration (1), it is possible to effectively and efficiently cool the turbine stator vane while reducing the complexity of the structure by utilizing the internal passage forming part.

(2) In some embodiments, in the above configuration (1), an effective cross-sectional area of the cooling passage in the second cross-section is smaller than an effective cross-sectional area of the cooling passage in the first cross-section.

With the above configuration (2), the effective cross-sectional area of the cooling passage in the second cross-section on the outer end side (radially outer side) is smaller than the effective cross-sectional area of the cooling passage in the first cross-section on the inner end side (radially inner side). Therefore, the flow velocity of the cooling fluid can be increased on the outer end side, where the cooling load is relatively high, so that the heat transfer coefficient between the cooling fluid and the turbine stator vane can be increased on the outer end side, whereas the increase in flow velocity of the cooling fluid can be suppressed on the inner end side, where the cooling load is relatively low, so that the pressure loss of the cooling fluid can be decreased to reduce the supply pressure (supply volume) of the cooling fluid. Thus, as described in the above (1), it is possible to effectively and efficiently cool the turbine stator vane while reducing the complexity of the structure.

(3) In some embodiments, in the above configuration (1) or (2), the turbine stator vane includes a plurality of cooling passages extending along the blade height direction inside the blade body. The internal passage forming part extends inside a leading-edge-side passage (e.g., the above-described cooling passage 54A) disposed closest to a leading edge (46) in a chord direction of the blade body among the plurality of cooling passages.

The turbine stator vane tends to be hotter near the leading edge during operation of the turbine. In this regard, with the above configuration (3), the internal passage forming part extends inside the leading-edge-side passage disposed closest to the leading edge among the plurality of cooling passages disposed inside the blade body. Therefore, the turbine stator vane can be cooled more effectively.

(4) In some embodiments, in any one of the above configurations (1) to (3), when an average position of the inner end in the blade height direction is a blade height position 0%, and an average position of the outer end in the blade height direction is a blade height position 100%, the first portion extends in the blade height direction within a range including a blade height position 50%.

With the above configuration (4), since the first portion of the internal passage forming part extends in the blade height direction within a range including the blade height position 50%, the second portion is located at a position closer to the outer end where the blade height position is more than 50%. Therefore, the flow velocity of the cooling fluid can be effectively increased on the outer end side, where the cooling load is relatively high, so that the heat transfer coefficient between the cooling fluid and the turbine stator vane can be effectively increased on the outer end side, whereas the increase in flow velocity of the cooling fluid can be suppressed in a region on the inner end side (region including the blade height position 50%), where the cooling load is relatively low, so that the pressure loss of the cooling fluid can be decreased to reduce the supply pressure (supply volume) of the cooling fluid. Thus, as described in the above (1), it is possible to effectively and efficiently cool the turbine stator vane while reducing the complexity of the structure.

(5) In some embodiments, in any one of the above configurations (1) to (4), when an average position of the inner end in the blade height direction is 0%, and an average position of the outer end in the blade height direction is 100%, the second portion is at least partially disposed within a range where the blade height position is not less than 75% and not more than 100%.

With the above configuration (5), since the second portion of the internal passage forming part is at least partially disposed within the range where the blade height position is not less than 75% and not more than 100%, the flow velocity of the cooling fluid can be effectively increased on the outer end side, where the cooling load is relatively high, so that the heat transfer coefficient between the cooling fluid and the turbine stator vane can be effectively increased on the outer end side, whereas the increase in flow velocity of the cooling fluid can be suppressed on the inner end side, where the cooling load is relatively low, so that the pressure loss of the cooling fluid can be decreased to reduce the supply pressure (supply volume) of the cooling fluid. Thus, as described in the above (1), it is possible to effectively and efficiently cool the turbine stator vane while reducing the complexity of the structure.

(6) In some embodiments, in the above configuration (5), the first portion includes a portion of the internal passage forming part where the blade height position is not less than 0% and not more than 50%.

With the above configuration (6), the first portion includes a portion of the internal passage forming part where the blade height position is not less than 0% and not more than 50%. That is, since most of the internal passage forming part on the inner end side is the first portion, the increase in flow velocity of the cooling fluid is suppressed in most of the internal passage forming part on the inner end side, so that the pressure loss of the cooling fluid can be decreased to effectively reduce the supply pressure (supply volume) of the cooling fluid. Thus, as described in the above (1), it is possible to effectively and efficiently cool the turbine stator vane while reducing the complexity of the structure.

(7) In some embodiments, in any one of the above configurations (1) to (6), the internal passage forming part includes a tubular member extending along the blade height direction between the outer end and the inner end, and a cover member covering a portion of the tubular member in the blade height direction from the periphery. The second portion includes the cover member.

With the above configuration (7), the internal passage forming part including the first portion and the second portion can be formed by the tubular member and the cover member. Thus, it is possible to achieve the above configuration (1) with a simple configuration.

(8) In some embodiments, in any one of the above configurations (1) to (7), the turbine stator vane includes a seal ring retaining ring (80) disposed on the opposite side to the blade body across the inner shroud in the blade height direction and forming the inner space together with the inner shroud. The internal passage forming part is configured to guide a seal fluid from the outer space to the inner space via the internal passage.

With the above configuration (8), a seal fluid can be guided from the outer space to the inner space via the internal passage formed by the internal passage forming part. That is, the internal passage forming part serves as a seal tube. Thus, with the above configuration (8), it is possible to effectively and efficiently cool the turbine stator vane having the internal passage forming part.

(9) A gas turbine (1) according to at least one embodiment of the present invention includes: a turbine (6) including the turbine stator vane (24) described in any one of the above (1) to (8); and a combustor (4) for producing a combustion gas to flow through a combustion gas passage (48) in which the turbine stator vane is disposed.

In the above configuration (9), a seal fluid can flow from the outer space to the inner space via the internal passage formed by the internal passage forming part. That is, the internal passage forming part can serve as a seal tube. Additionally, in the above configuration (9), since the area enclosed by the outer edge of the second portion in the second cross-section perpendicular to the blade height direction is larger than the area enclosed by the outer edge of the first portion in the first cross-section, the flow path area of the cooling fluid flowing through the cooling passage (effective cross-sectional area of cooling passage) tends to be relatively large on the outer end side (radially outer side) and relatively small on the inner end side (radially inner side) in the blade height direction. Therefore, the flow velocity of the cooling fluid can be increased on the outer end side, where the cooling load is relatively high, so that the heat transfer coefficient between the cooling fluid and the turbine stator vane can be increased on the outer end side, whereas the increase in flow velocity of the cooling fluid can be suppressed on the inner end side, where the cooling load is relatively low, so that the pressure loss of the cooling fluid can be decreased to reduce the supply pressure (supply volume) of the cooling fluid. Therefore, the turbine stator vane can be cooled effectively and efficiently.

Thus, with the above configuration (9), it is possible to effectively and efficiently cool the turbine stator vane while reducing the complexity of the structure by utilizing the internal passage forming part.

Embodiments of the present invention were described in detail above, but the present invention is not limited thereto, and various amendments and modifications may be implemented.

In the present specification, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, an expression of a shape such as a rectangular shape or a cylindrical shape shall not be construed as only the geometrically strict shape, but also includes a shape with unevenness or chamfered corners within the range in which the same effect can be achieved.

On the other hand, an expression such as “comprise”, “include”, and “have” are not intended to be exclusive of other components.

1. A turbine stator vane, comprising:
a blade body having an outer end and an inner end in a blade height direction;
a cooling passage extending along the blade height direction inside the blade body;
an outer shroud connected to the blade body at the outer end side of the blade body in the blade height direction;
an inner shroud connected to the blade body at the inner end side of the blade body in the blade height direction; and
an internal passage forming part extending along the blade height direction inside the cooling passage,
wherein the internal passage forming part forms an internal passage communicating with each of an outer space on an opposite side to the blade body across the outer shroud and an inner space on an opposite side to the blade body across the inner shroud,
wherein the internal passage forming part has:
a first portion; and
a second portion disposed closer to the outer end than the first portion in the blade height direction, and
wherein an area enclosed by an outer edge of the second portion in a second cross-section perpendicular to the blade height direction is larger than an area enclosed by an outer edge of the first portion in a first cross-section perpendicular to blade height direction.

2. The turbine stator vane according to claim 1,
wherein an effective cross-sectional area of the cooling passage in the second cross-section is smaller than an effective cross-sectional area of the cooling passage in the first cross-section.

3. The turbine stator vane according to claim 1, comprising a plurality of cooling passages extending along the blade height direction inside the blade body,
wherein the internal passage forming part extends inside a leading-edge-side passage disposed closest to a leading edge in a chord direction of the blade body among the plurality of cooling passages.

4. The turbine stator vane according to claim 1,
wherein when an average position of the inner end in the blade height direction is a blade height position 0%, and an average position of the outer end in the blade height direction is a blade height position 100%, the first portion extends in the blade height direction within a range including a blade height position 50%.

5. The turbine stator vane according to claim 1,
wherein when an average position of the inner end in the blade height direction is 0%, and an average position of the outer end in the blade height direction is 100%, the second portion is at least partially disposed within a range where the blade height position is not less than 75% and not more than 100%.

6. The turbine stator vane according to claim 5,
wherein the first portion includes a portion of the internal passage forming part where the blade height position is not less than 0% and not more than 50%.

7. The turbine stator vane according to claim 1,
wherein the internal passage forming part includes
a tubular member extending along the blade height direction between the outer end and the inner end, and
a cover member covering a portion of the tubular member in the blade height direction from periphery, and
wherein the second portion includes the cover member.

8. The turbine stator vane according to claim 1, comprising a seal ring retaining ring disposed on the opposite side to the blade body across the inner shroud in the blade height direction and forming the inner space together with the inner shroud,
wherein the internal passage forming part is configured to guide a seal fluid from the outer space to the inner space via the internal passage.

9. A gas turbine, comprising:
a turbine including the turbine stator vane according to claim 1; and
a combustor for producing a combustion gas to flow through a combustion gas passage in which the turbine stator vane is disposed.
